(19) United States
(12) Patent Application Publication
(10) Pub. No.: US 2026/0108908 A1
(43) Pub. Date: Apr. 23, 2026

(54) ROTARY MECHANISM WITH PERIODIC REVERSE MOTION

(71) Applicant: GEBZE TEKNIK UNIVERSITESI, Kocaeli (TR)

(72) Inventors: Mahmut AKSIT, Istanbul (TR); Elif Sena Gur, Istanbul (TR)

(73) Assignee: GEBZE TEKNIK UNIVERSITESI, Kocaeli (TR)

(21) Appl. No.: 19/428,404

(22) Filed: Dec. 22, 2025

Related U.S. Application Data
(63) Continuation of application No. PCT/TR2023/050614, filed on Jun. 22, 2023.

(51) Int. Cl. B05C 19/00; F16H 19/08

(52) U.S. Cl. CPC B05C 19/00; F16H 19/08

(57) ABSTRACT

The provided is a rotary mechanism configured to generate periodic reverse rotational motion while providing a net forward rotation. The rotary mechanism includes a central shaft defining a central rotation axis, a rotating actuator arranged to drive the central shaft, and an applicator surface configured for powder coating and arranged to rotate about the central rotation axis. The rotating actuator drives a first external gear associated with the central shaft. A second external gear is arranged in meshing engagement with the first external gear and is rotatable relative to the central shaft. A connection rod is connected at a first end to the applicator surface at a location radially offset from the central rotation axis and at a second end to a radially offset connection feature associated with the second external gear.

### CROSS-REFERENCE TO THE RELATED APPLICATIONS

This application is a continuation application of International Application No. PCT/TR2023/050614, filed on June 22, 2023, the entire contents of which are incorporated herein by reference.

### TECHNICAL FIELD

The present invention relates to a rotary mechanism that provides periodic reverse motion and includes the application surface that moves with the movement of the rotating actuator.

### BACKGROUND

In the coating of dry powders or powders mixed with liquids, and especially powders in the form of plates and nanoplates, it is important to mobilize the powders in the directions parallel to the surface to be coated by applying forces parallel to the surface while applying pressure on the powders perpendicular to the surface. Currently, there are polishing, buffing, and sanding machines on the market that make regular rotational movements, linear reciprocating movements, and orbital movements in pseudo-random or deterministic varying directions. Although the regular rotational movements and orbital movements in random or deterministic varying directions ensure the movement of the powders in the directions parallel to the surface, these types of movement are unidirectional such that there is no reverse movement of the powder particles as they are being applied to the surface. In mechanisms that make forward and backward linear movements, the powder does not circulate over the entire surface but is applied locally.

Thanks to the mechanism developed within the scope of the present invention, a cyclically moving powder applicator surface rotates in a certain direction while making preferably periodic repetitive returns and the forward motion is longer than the backward motion such that a net forward motion is ensured after forward-backward cycles are completed. As a result, the powders to be coated on the surface are effectively applied to the surface by both back-and-forth motion and bi-directional shear force, and the powders that could not be fed to the surface are transported to the other positions on the surface by the net forward motion to enable a more uniform coating. Drawings of this newly developed mechanism are presented in this document.

In the technical area, there are also vibration assisted mechanisms that allow powder coating with increased effectiveness. A previous patent with publication number US2022395857 describes the solution related to a vibrating powder coating device that can suppress the radial flow occurring on the dust containing surface. However, in this previous invention, while the first external gear makes a conventional forward rotation movement, there is no rotary mechanism solution that intermittently or periodically makes repetitive reverse movements on the implementing surface.

### SUMMARY

The current invention relates to a rotary mechanism in order to eliminate the above-mentioned disadvantages of the previous art and bring new advantages to the relevant technical field.

The main objective of the invention is to provide a rotary mechanism that intermittently or periodically exhibits repetitive reverse movements but also makes a net forward rotation movement as a result of the cyclical forward and reverse movements.

Another objective of the present invention is to provide a rotary mechanism that moves back and forth by creating a motion transmission mechanism thanks to its connections with the connecting rod.

In order to achieve the above-mentioned objectives and those that will become apparent from the detailed description below, the present invention relates to a rotary mechanism (10) comprising a central shaft (24) defining a central rotation axis, a rotating actuator (32) arranged to drive the central shaft (24), and an applicator surface (16) configured for powder coating and arranged to rotate about the central rotation axis.

The rotary mechanism (10) comprises a first external gear (28) driven by the rotating actuator (32) and associated with the central shaft (24), the first external gear (28) having a circumferential gear structure provided on an outer lateral surface thereof. A second external gear (30) is arranged in meshing engagement with the circumferential gear structure of the first external gear (28) and is rotatable relative to the central shaft (24), the second external gear (30) likewise having a circumferential gear structure.

A connecting rod (20) is connected at a first end to the applicator surface (16) at a location radially offset from the central rotation axis via a first bearing (18), thereby providing rotational freedom between the applicator surface (16) and the central shaft (24). The connecting rod (20) is connected at a second end to a radially offset connection feature formed on or associated with the second external gear (30), preferably via a cylindrical extension (22), such that the connecting rod (20) is articulated with rotational freedom at both ends. This configuration provides a motion transmission mechanism by which continuous forward rotation of the first external gear (28) produces periodic reverse rotational motion of the applicator surface (16), while still resulting in a net forward rotation of the applicator surface (16).

Accordingly, a rotary mechanism (10) is provided that generates periodic reverse rotational motion and is particularly suitable for polishing, sanding, and powder coating processes.

In a preferred embodiment of the invention, the rotary mechanism (10) further comprises an internal gear (26) having an internal circumferential gear structure and arranged to surround the first external gear (28) and the second external gear (30), the internal gear (26) being fixed relative to a reference frame of the rotary mechanism. In this manner, the external gears (28, 30) are mechanically constrained by the internal gear (26) to establish the desired motion transmission within the mechanism.

In another preferred embodiment, the internal gear (26) is fixed relative to the reference frame by one or more stabilizer pieces (12, 14), which may be coupled to the rotating actuator (32) or to a stationary structural component of the rotary mechanism (10).

In another preferred embodiment, a second bearing (38) is arranged coaxially with the central shaft (24), an outer ring of the second bearing (38) being fixed relative to the reference frame by the stabilizer piece or pieces (12, 14), and an inner ring of the second bearing (38) being coupled to the central shaft (24). In this way, radial support is provided to the central shaft (24) to prevent wobbling while permitting rotational freedom of the central shaft (24) relative to the stabilizer piece or pieces.

In a further preferred embodiment, the stabilizer piece arrangement comprises a first stabilizer piece (12) and a second stabilizer piece (14) secured together by multiple nuts (34), thereby increasing the structural rigidity of the rotary mechanism (10) during operation.

### BRIEF DESCRIPTION OF THE DRAWINGS

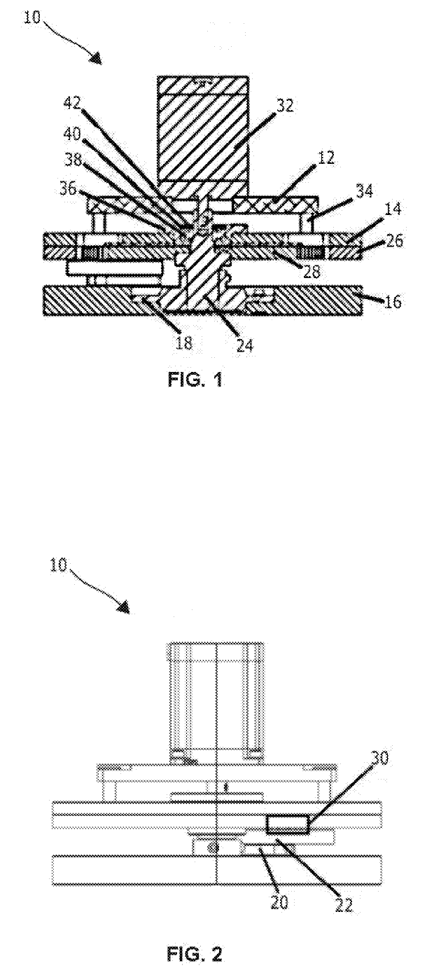

In FIG. 1, a side perspective representation of the rotary mechanism, the subject of the invention, is given.

In FIG. 2, it is a continuation of FIG. 1.

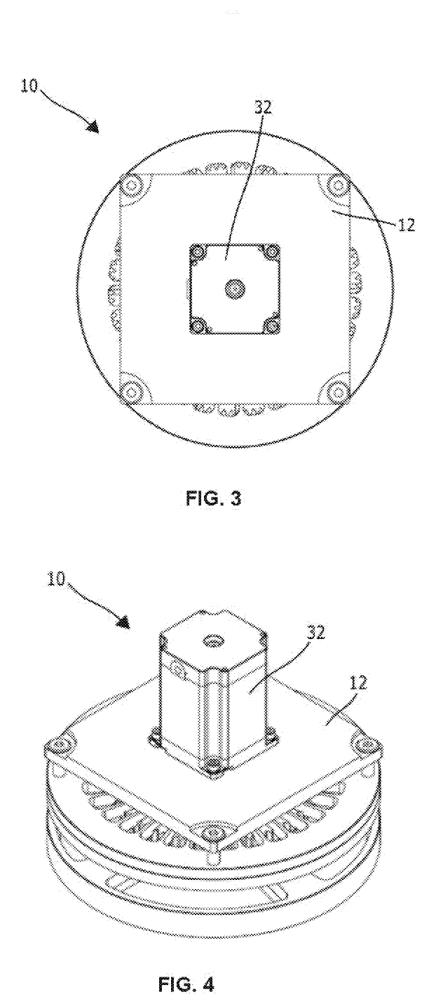

In FIG. 3, a representation of the rotary mechanism, the subject of the invention, is given from the upper perspective.

In FIG. 4, a representation of the rotary mechanism, the subject of the invention, is given from a preliminary perspective.

### DETAILED DESCRIPTION OF THE EMBODIMENTS

In the following detailed description of the invention, exemplary embodiments of a rotary mechanism are described for purposes of explanation and illustration only. These embodiments are not intended to limit the scope of the invention, which is defined solely by the appended claims.

Referring to FIGS. 1-4, the rotary mechanism (10) according to the present invention is illustrated in various sectional, perspective, and plan views. The rotary mechanism (10) comprises a central shaft (24) defining a central rotation axis, a rotating actuator (32) arranged to drive the central shaft (24), and an applicator surface (16) configured for powder coating and arranged to rotate about the central rotation axis.

The applicator surface (16) is rotatably mounted on the central shaft (24) via a first bearing (18), such that the applicator surface (16) remains coaxial with the central shaft (24) while having rotational freedom relative thereto. This configuration allows the applicator surface (16) to undergo controlled rotational motion independent of the direct rotation of the central shaft (24).

The rotating actuator (32), which may be a DC motor, AC motor, internal combustion motor, or another suitable rotary drive source, has an output shaft that is non-rotatably connected to the central shaft (24), such that the rotating actuator (32) and the central shaft (24) rotate together about the central rotation axis.

A first external gear (28) is associated with the central shaft (24) and rotates together with the central shaft (24). The first external gear (28) has a circumferential gear structure provided on its outer lateral surface. A second external gear (30) is arranged in meshing engagement with the circumferential gear structure of the first external gear (28). The second external gear (30) is rotatable relative to the central shaft (24) and is not rigidly fixed to the central shaft (24).

A connection rod (20) is connected at a first end to the applicator surface (16) at a location radially offset from the central rotation axis. This connection is provided via a bearing, thereby permitting rotational freedom between the connection rod (20) and the applicator surface (16). A second end of the connection rod (20) is connected to a cylindrical extension (22) associated with the second external gear (30), the connection being radially offset from a rotation axis of the second external gear (30) and permitting rotational freedom at the connection.

Through this arrangement, continuous forward rotation of the first external gear (28), driven by the rotating actuator (32), produces a cyclic motion in which the applicator surface (16) undergoes periodic reverse rotational motion while achieving a net forward rotation over each motion cycle. This combined motion produces bidirectional shear forces on material applied to the applicator surface (16), while also ensuring transport of material across the surface due to the net forward rotation.

In a preferred embodiment, the rotary mechanism (10) further comprises an internal gear (26) having an internal circumferential gear structure and arranged to surround the first external gear (28) and the second external gear (30). The second external gear (30) is arranged in meshing engagement with the internal circumferential gear structure of the internal gear (26). The internal gear (26) is fixed relative to a reference frame of the rotary mechanism (10), thereby defining a stationary gear element that constrains the motion of the second external gear (30).

The internal gear (26) is fixed relative to the reference frame by one or more stabilizer pieces, including a first stabilizer piece (12) and optionally a second stabilizer piece (14). The stabilizer pieces (12, 14) may be coupled to the rotating actuator (32) and/or to another stationary structural component of the rotary mechanism (10), and may be secured using fasteners such as nuts (34).

In a further preferred embodiment, a second bearing (38) is arranged coaxially with the central shaft (24). An outer ring of the second bearing (38) is fixed relative to the reference frame by the stabilizer piece(s) (12, 14), while an inner ring of the second bearing (38) is coupled to the central shaft (24), optionally via a bearing coupler (36). The second bearing (38) provides radial support to the central shaft (24) to suppress wobbling or lateral displacement, while permitting relative rotation between the central shaft (24) and the stabilizer piece(s). The second bearing (38) may be retained using a first circlip (40) and a second circlip (42).

The described configuration enables the rotary mechanism (10) to be used effectively in polishing, sanding, and powder coating processes, particularly where controlled bidirectional shear and uniform material distribution across an applicator surface are desired.

In further embodiments, the period of the periodic reverse rotational motion of the applicator surface (16) may be adjusted by altering the relative diameters and/or gear tooth counts of the first external gear (28) and the second external gear (30). Additionally, the angular stroke of the reverse rotational motion may be adjusted by changing one or more of:

(i) a radial position at which the connection rod (20) is connected to the cylindrical extension (22) of the second external gear (30);

(ii) a radial position at which the connection rod (20) is connected to the applicator surface (16); and/or

(iii) a length of the connection rod (20) relative to one or both of the above radial positions.

Through these adjustments, the kinematic characteristics of the applicator surface motion can be tuned to suit specific process requirements.

### REFERENCE NUMBERS

10 Rotary mechanism

12 First stabilizer piece

14 Second stabilizer piece

16 Applicator surface

18 First bearing

20 Connection rod

22 Cylindrical extension

24 Central shaft

26 Internal gear

28 First external gear

30 Second external gear

32 Rotating actuator

34 Nuts

36 Bearing coupler

38 Second bearing

40 First circlip

42 Second circlip

1. A rotary mechanism, comprising:
a central shaft defining a central rotation axis;
a rotating actuator arranged to drive the central shaft;
and an applicator piece arranged to rotate about the central rotation axis,
wherein
the rotating actuator drives a first external gear associated with the central shaft, the first external gear having a circumferential gear structure;
a second external gear is arranged in meshing engagement with the circumferential gear structure of the first external gear and is rotatable relative to the central shaft;
a connecting rod is connected at a first end to the applicator piece at a location radially offset from the central rotation axis with rotational freedom and is connected at a second end to a radially offset connection feature associated with the second external gear with rotational freedom;
wherein continuous forward rotation of the first external gear produces periodic reverse rotational motion of the applicator piece while providing a net forward rotation of the applicator piece.

2. The rotary mechanism according to claim 1, wherein
the rotary mechanism further comprises an internal gear having an internal circumferential gear structure and arranged to surround the first external gear and the second external gear,
the internal gear being fixed relative to a reference frame of the rotary mechanism.

3. The rotary mechanism according to claim 1, wherein
the applicator piece is rotatably mounted on the central shaft, wherein the applicator piece has rotational freedom relative to the central shaft while remaining coaxial with the central shaft.

4. The rotary mechanism according to claim 1, wherein
an output shaft of the rotating actuator is non-rotatably connected to the central shaft, wherein the output shaft and the central shaft rotate together about the central rotation axis.

5. The rotary mechanism according to claim 2, wherein
the internal gear is fixed relative to the reference frame by at least one stabilizer piece coupled to the rotating actuator or to a stationary structural component of the rotary mechanism.

6. The rotary mechanism according to claim 5, wherein
a bearing is arranged coaxially with the central shaft,
an outer ring of the bearing being fixed relative to the reference frame by the at least one stabilizer piece,
and an inner ring of the bearing being coupled to the central shaft,
the bearing providing radial support to the central shaft while permitting relative rotation between the central shaft and the at least one stabilizer piece.

7. The rotary mechanism according to claim 1, wherein
continuous rotation of the rotating actuator, the central shaft, and the first external gear in a single rotational direction causes the applicator piece to undergo a cyclic rotational motion comprising alternating forward and reverse rotational components,
the reverse rotational component having a smaller angular extent than the forward rotational component, wherein each cycle results in a net forward rotation of the applicator piece.

8. The rotary mechanism according to claim 1, wherein
an angular extent of the reverse rotational component of the applicator piece is adjustable by at least one of:
i) changing a radial offset of a connection between the connecting rod and the second external gear,
ii) changing a radial offset of a connection between the connecting rod and the applicator piece, and
iii) changing a length of the connecting rod.

9. The rotary mechanism according to claim 1, wherein
the applicator piece is an applicator surface configured for powder coating.

10. The rotary mechanism according to claim 2, wherein
an output shaft of the rotating actuator is non-rotatably connected to the central shaft, wherein the output shaft and the central shaft rotate together about the central rotation axis.

11. The rotary mechanism according to claim 3, wherein
an output shaft of the rotating actuator is non-rotatably connected to the central shaft, wherein the output shaft and the central shaft rotate together about the central rotation axis.
